(19) United States
(12) Patent Application Publication
(10) Pub. No.: US 2004/0046523 A1
(43) Pub. Date: Mar. 11, 2004

(54) Method and apparatus for storing and using motor parameters in a servo control system for tuning

(76) Inventors: Jeffrey G. Knirck, Sunnyvale, CA (US); Paul A. Swanson, Cupertino, CA (US)

Correspondence Address: Jeff Knirck, 868 Jasmine Dr., Sunnyvale, CA, 94086, US

(21) Appl. No.: 10/238,059

(22) Filed: Sep. 10, 2002

(51) Int. Cl. G05D 23/275

(52) U.S. Cl. 318/632

(57) ABSTRACT

A means for an servo controller to use predetermined and stored parameters of the servo components to perform tuning of the servo system is disclosed. The present invention relates to tuning, compensating, returning or recompensating a servo system given the pertinent parameters of the servo components such as the motor, the load and the feedback sensor. The method is ideal for galvanometers and servo motors when the implementation includes incorporation of a memory device into the motor to store the motor constants.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to tuning a servo system containing a servomotor as an example of a servo component that has unique performance characteristics derived through manufacturing tolerances.

Servomotor systems are commonly used in industry to precisely control positions or motion of objects. Servomotor systems are frequently capable of extremely precise and or quick motion. Such systems are used for applications ranging from scanning mirrors in optical instruments to conveyers. To attain high performance the servo system must be tuned to account for the load parameters and some parameters of the servomotor itself.

Servo systems come in various configurations, but they all have some common elements and problems. Servo systems can be “open-loop” or “closed-loop”. Closed-loop systems use active feedback information to aid control. Open-loop systems do not. All servo systems include a motor, a load that is driven by the motor, and a motion controller that controls and drives the motor in accordance with some external command. The motion controller includes sophisticated control logic and a power amplifier to drive the motor. The control logic uses the external command and a control law that is dependent on the motor and load parameters to drive the motor to produce the desired motion. Inertia is frequently the one most pertinent parameter of the load. If the servo system is closed-loop, feedback information is also used. The feedback transducer is frequently included inside the motor in the forma of a position sensor or tachometer. The control law is programmed into the controller either as software or hardware values. This programming process is called “tuning” or “compensating”. Determining the control law coefficients is usually done empirically. All servo systems must be tuned or compensated to attain the desired performance. Closed-loop servo systems must be tuned just to insure stability. Tuning a high performance servo system requires a high level of skill.

In addition to the initial tuning, a problem recurs when a motor, load or feedback sensor is replaced due to wear or damage. Typically this replacement requires returning because not all loads or motors are identical. The returning must be done at a relatively high labor rate and may result in slightly different servo performance than the original, due to the subjectivity of tuning.

An alternative to manual returning by a skilled technician is “auto-tuning”. Auto-tuning is sometimes employed in high end applications that include a computer and a feedback system. Such systems are typically large and expensive and only practical in limited circumstances. Auto-tuning is accomplished by exciting the servo system with a known signal by a computer. The computer monitors the reaction of the system and iterates the tuning parameters to converge on good tuning. Servo system tuning can be very subjective and the performance objectives of servo systems vary significantly. The compensation produced by an auto-tune algorithm may not be the best tuning for some applications. Further, the process of auto-tuning may not be appropriate in the field when driving a potentially sensitive load or dangerous consequences can occur during this sometime violent characterization process.

A new, simple and universally applicable method would require knowing the pertinent parameters of each load, motor and feedback sensor (if one is used). A servo controller with a modest level of intelligence could use the known parameters to compensate the servo system or to modify preexisting compensation for any slight change in parameters from the old load or motor to a new load or motor. The motor, load and feedback sensor parameters could be entered into a computer that would determine the correct servo compensation parameters. In the case of the motor, it would be nice if the motor manufacturer could include a memory device in the motor that the servo controller could interrogate to read the pertinent parameters of the motor.

Clare et al U.S. Pat. No. 6,342,985 (1/2002) teaches about “compensation for variation in a voice coil motor's torque factor” and that the pertinent factor “can be stored in memory”. Clare is differentiated from the present invention by both purpose and means. Clare is specifically concerned about the temperature coefficient of torque of a motor. Clare teaches that periodically sampling the temperature of the motor and testing the torque capability can deduce the temperature coefficient of torque of a motor by the controller. The data can be stored in the controller to aid in predicting future performance. This process is done in situ for a disk drive system that will never have its motor and controller separated. The process described by Clare is a specific variation on “auto-tuning”. The present invention relies on a memory imbedded in a motor separate from a controller. The memory contains data stored in the motor by the motor manufacturer so that the controller can access it to aid in tuning or returning.

Cunningham et al U.S. Pat. No. 5,854,722 (12/1998) teaches about a “compensation correction method”. Cunningham is differentiated from the present invention by both purpose and means. Cunningham describes a method to modify a feed forward signal to correct for an arched trajectory. This process is all predetermined and programmed into the controller. No new information is being read. No permanent control law changes are being made. Cunningham's process is actually all self contained within the servo controller part of the disc drive.

Overton et al U.S. Pat. No. 4,786,990 (11/1988) teaches about a “compensation for servo gain variations” and “storing the individual gain corrections”. Overton is differentiated from the present invention by both purpose and means. Overton describes a system that learns about “gain corrections for each magnetic head at several selected tracks”. The process described by Overton is also a specific variation on “auto-tuning”.

Other References Cited

| | | |
|---|---|---|
| 6,204,988 | May 2001 | Codilian |
| 5,649,062 | July 1997 | Teng |

### BRIEF SUMMARY OF THE INVENTION

The principal object of the present invention is to provide a means for an intelligent servo controller to use predetermined and stored parameters of the servo components to perform automatic compensation of the servo system.

The present invention can accomplish this general objective in a few ways. A small memory device could be incorporated into each servomotor. The memory device would contain the predetermined pertinent parameters of the servomotor. Additionally, an intelligent servo controller is provided that is capable of reading the memory in the servomotor and appropriately compensating the predetermined servo parameters. This scheme provides for automatic returning of a servo system after a motor is replaced. Presumably the servo system was already tuned. Alternatively, the intelligent servo controller, or an external computer, could calculated the necessary initial servo compensation based on pertinent servo constants such as torque constant, feedback gain and load inertia.

The present invention would be ideal for use in galvanometers and other linear or rotary motor servo controlled positioning stages. Other uses, objects, features and advantages of the present invention will become apparent from the following detailed description when taken in conjunction with the accompanying drawings.

### BRIEF DESCRIPTION OF THE DRAWINGS

FIG. 1 is a block diagram of a servo-controlled system.

### DETAILED DESCRIPTION OF THE INVENTION

The present invention provides a means to automatically tune or retune a servo system based on knowledge of critical servo constants like torque constant. A means of electronically storing and attaching the motor constants to the motor is also disclosed. The advantage of the present invention is that it eliminates or greatly simplifies servo system initial tuning, or returning after a critical component like a motor is replaced.

The details of the present invention can be implemented in numerous variations of configuration and components. In any case the basic concept is the same. Various types or configurations of servo controllers, memory devices and processing algorithms could be used with a variety of servo systems that include a variety of components.

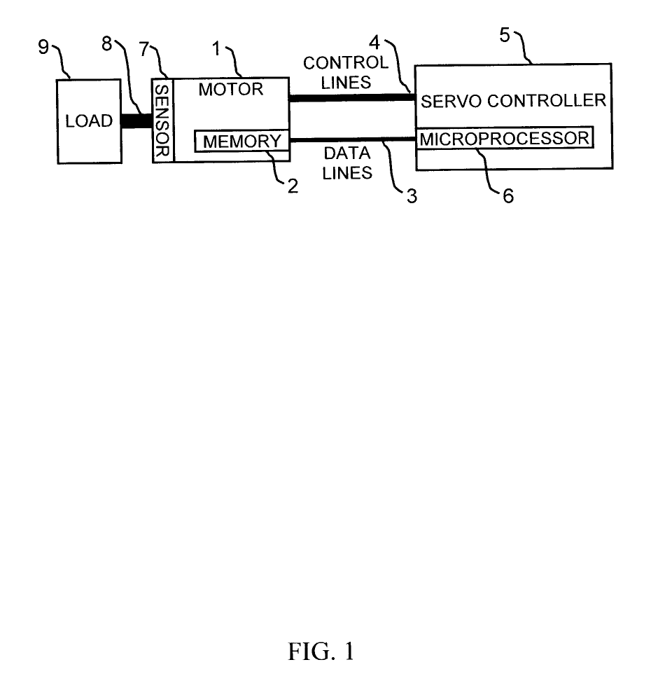

FIG. 1 shows a block diagram of a servo-controlled system. The servo system includes a Servo Controller 5, a Motor 1, and a Load 9. The motor could be a linear or a rotary motor. The motor could be a conventional electro-magnetic motor, a piezo-electric motor, or a hydraulic actuator. The Load is at least a simple inertia. It could be a mechanical or a thermal inertia. The load may be more complex. The load may include a spring constant, a damping constant, friction, stiction or resonances. The Load is shown attached to the Motor with a Mechanical Coupling 8. The Mechanical Coupling could be a shaft or a belt, or many other devices to couple the force of the motor to the load. A Sensor 7 is shown attached to the Motor 1. The Sensor 7 could alternatively be connected directly to the Load 9. Sometimes the servomotor manufacturer incorporates a feedback sensor into the servomotor. The Sensor 7 could be a position, velocity or a force transducer, or the rotary, thermal or fluidic equivalents. The Motor 1 is shown with a Memory 2 incorporated into it, or physically attached to it. This Memory is used to store pertinent motor parameters. Control Lines 4 between the Motor and the Servo Controller is shown. The Control Lines provide power and feedback, if any, between the Motor and the Servo Controller. The Servo Controller 5 is shown with a Microprocessor 6 incorporated into it. This Microprocessor is used to read the stored store pertinent motor parameters and aid in processing them to produce or modify the actual servo control parameters. Data Lines 3 between the Motor and the Servo Controller is shown. The Control Lines provide a path between the Memory 2 and the Microprocessor 6 so that the Servo Controller 5 can interrogate the motor to determine its pertinent servo parameters.

The present invention is a servo control system that can include a servo controller with some intelligence, or access to some intelligence, so that accurately predetermined constants important to the servo system can be entered and processed to automatically tune the servo system, or retune for a changed component. Herein, various servo system components like motors and loads will be discussed as examples. Sometimes the linear case will be discussed, and sometimes the rotary case will be discussed. In the more generic case they are interchangeable, and can be further generalized to the case of a temperature, fluidic or optical servo system.

For the case of initial tuning, the simplest case of an open-loop position control system with a linear force motor working against a load inertia and a spring is described. The force constant of the motor, the total inertia and the spring constant are all that is required to fully characterize and therefore control the position of the load. A mathematical algorithm that describes how to optimally drive the motor to move the load to a desired position can be easily derived. Given the appropriate servo component constants, the coefficients of this algorithm can be determined in a servo controller with some intelligence, or access to some intelligence like an external computer. An intelligent servo controller could have the means within the servo controller for using the pertinent motor servo parameters, or other servo system component servo parameters, to compensate the servo system. The algorithm, with the appropriate coefficients, can be stored and executed in the servo controller to control the load.

For the present invention, in contrast to “auto-tuning”, the appropriate servo component constants, like the force constant of the motor, the total inertia and any feedback constant must be entered into the servo controller so that the control coefficients can be calculated. The servo component constants must also be known accurately to produce the best tuning. The user usually provides the load, so the load inertia must be determined by the user and entered into the controller. Feedback sensors are usually purchased and their constants are provided. The constants of some feedback sensors are known and reported accurately, and some are not. Motors frequently have a large variation even between supposedly identical units. The pertinent motor servo parameters are particularly important to a servo system. These parameters, like torque constant and inertia, are typically specified loosely by the manufacturer. These parameters are typically difficult for the user to measure, but relatively easy for the manufacturer to measure and report. An element of the present invention is for the motor manufacturer to include documentation preferable in the form of an electronic memory device inside the motor that contains the accurate values of the pertinent motor servo parameters like the torque constant. It would be advantageous if a similar memory device were incorporated into each element of the servo system. A servo controller that is capable of reading the memory could then use the information to compensate the servo system. Some motors, like galvanometers, frequently contain integral position sensors or tachometers. In this case the memory device in the motor would also contain the pertinent feedback sensor constants.

For the case of returning, the more complicated case of a closed-loop position control system is described that includes a linear force motor positioning a load inertia with the aid of a position feedback sensor. Presumably the servo system is executing a classical (PID) Proportional-Integral-Denvative control law, although the present invention would be effective with any control law type. The most common case is that the motor or the position sensor has failed. With the present invention the scenario would be as follows. The old motor and position sensor assembly included a memory device containing the pertinent constants. The servo system was tuned using a servo controller that was capable of reading the memory and could use the information to compensate the servo system. A new motor and position sensor assembly is substituted for the failed unit. The servo controller contains a means, like a microprocessor, for reading a memory associated with a servo system component. The servo controller reads the new servo component parameters. The servo controller has a means, like a microprocessor, for using the contents of the memory to compensate the servo system. The servo controller detects that a change has occurred in one or more of the parameters. The servo controller detects the change by comparing the new set of pertinent motor servo parameters with a reference set of pertinent motor servo parameters stored in the servo controller. The reference set of pertinent motor servo parameters could be a “gold-standard” set of ideal values or simply the old values from the replaced assembly. The servo controller then uses the pertinent motor servo parameters to compensate the servo system by adjusting the PID coefficients. This returning would be incremental, relatively robust, automatic, and would probably preserve the style of the original tuning.

The most basic implementation for the returning case involving a motor and a position feedback sensor would be as follows. The old motor assembly to be replaced, including the position feedback sensor, has an accurately known torque constant and an accurately known position feedback constant that are written on the motor assembly. The servo constant associated with the servo component to be replaced is noted. The old motor assembly is replaced with a similar new motor assembly with an accurately known torque constant and an accurately known position feedback constant that are written on the new motor assembly. The servo constant associated with the replacement servo component is noted. The servo controller has a resistor or a memory register that determines the amplifier gain coefficient and another resistor or memory register that determines the position feedback gain coefficient. To effectively retune the old amplifier the gain coefficient is replaced with a new amplifier gain coefficient that is equal to the old amplifier gain coefficient multiplied by the ratio of the new torque constant divided by the old torque constant. The old position feedback gain coefficient is replaced with a new position feedback gain coefficient that is equal to the old position feedback gain coefficient multiplied by the ratio of the new position feedback constant divided by the old position feedback constant. In general, the old servo control law coefficient is replaced with a new servo control law coefficient that is equal to the old servo control law coefficient multiplied by the servo constant associated with a servo component to be replaced divided by the servo constant associated with a replacement servo component.

Many physical constants of servo components can be utilized in this same way by an intelligent servo controller. Some of them would be practical to store in memories incorporated into the servo component by the component manufacturer. Here is a list of other physical constants of potential servo components: physical limits, resonances, position offset, inductance, resistance, gear ratio, current limit, velocity limit, spring constant, heat capacity, and temperature coefficients of all of the preceding constants.

The above descriptions are illustrative and not restrictive. Many variations of the invention will become apparent to those skilled in the art upon review of this disclosure. Merely by way of example, various means can be used to store the servo component values, like embedded electronic memory or and accompanying compact disc. Various types of control laws can by used by the servo controller. The majority of the compensation computation could be done in an external tabletop computer or it could be executed by a microprocessor onboard the servo controller. The present invention could be used in various applications varying from an embedded subsystem of a medical instrument to move an optic, to the prime mover of an industrial conveyer system.

The scope of the invention should therefore be determined not just with reference to the above description, but instead should be determined with reference to the appended claims along with their full scope of equivalents.

We claim:

1. An apparatus for automatically compensating a servo system, comprising:
a motor;
an electronic memory means, associated with the motor, that contains pertinent motor servo parameters;
a servo controller that is capable of reading the memory means; and
a means within the servo controller for using the pertinent motor servo parameters to compensate the servo system.

2. An apparatus of claim 1 where the electronic memory means is physically attached to the motor.

3. An apparatus of claim 1 where the electronic memory means contains a torque constant of the motor.

4. An apparatus of claim 1 where the electronic memory means contains a feedback sensor constant.

5. An apparatus of claim 1 where the servo controller contains a means to compare a set of pertinent motor servo parameters with a reference set of pertinent motor servo parameters stored in the servo controller.

6. A method for automatically compensating a servo system, comprising the steps of:
reading pertinent motor servo parameters from an electronic memory means associated with a motor into a servo controller;
compensating the servo system using the pertinent motor servo parameters.

7. A method of claim 6 further comprising the steps of:
comparing a set of pertinent motor servo parameters with a reference set of pertinent motor
servo parameters stored in the servo controller.

8. A method for automatically compensating a servo system, comprising the steps of:
entering pertinent motor servo parameter associated with a motor into a computer;
comparing the pertinent motor servo parameter with a reference pertinent motor servo parameter; and
compensating the servo system using the pertinent motor servo parameter.

9. An apparatus for automatically compensating a servo system, comprising:
a servo system component;
an electronic memory means, associated with the servo system component, that contains a pertinent servo system component servo parameter;
a servo controller that is capable of reading the memory means; and
a means within the servo controller for using the pertinent servo system component servo parameter to compensate the servo system.

10. An apparatus of claim 9 where the servo system component is a motor.

11. An apparatus of claim 9 where the servo controller compares the servo parameter with a previously stored value.

12. A method for returning a servo system, comprising the steps of:
noting a servo constant associated with a servo component to be replaced;
noting a servo constant associated with a replacement servo component; and
replacing an old servo control law coefficient with a new servo control law coefficient that is equal to the old servo control law coefficient multiplied by the servo constant associated with a servo component to be replaced divided by the servo constant associated with a replacement servo component.

13. An apparatus for automatically compensating a servo system, comprising:
a servo controller;
a means within the servo controller for reading a memory associated with a servo system component; and
a means within the servo controller for using content of the memory associated with a servo system component to compensate the servo system.
